(19) United States
(12) Patent Application Publication
(10) Pub. No.: US 2011/0031341 A1
(43) Pub. Date: Feb. 10, 2011

(54) AUTOMATIC POSITIONING WINDER

(76) Inventor: Lizhi He, Guangdong (CN)

Correspondence Address: SALLY CHANG, 3F-8 No.6, SEC. 6 CHUNG-HSIAO EAST RD., TAIPEI, TAIWAN, R.O.C. 115, TAIPEI, 115, TW

(21) Appl. No.: 12/936,515

(22) PCT Filed: May 20, 2009
(86) PCT No.: PCT/CN2009/000551

§ 371 Date: Oct. 5, 2010

(30) Foreign Application Priority Data
May 20, 2008 (CN) 200810028183.2

(51) Int. Cl. B65H 75/48; B65H 75/44; H02G 11/02

(52) U.S. Cl. 242/388.1

(57) ABSTRACT

An automatic positioning winder comprises a lower cover (1), an upper cover (2) fixedly connected with the lower cover (1), a winding device quipped between the lower and upper covers, entering and outgoing line holes (10, 11) formed in the lateral walls of the lower and upper covers respectively. The winding device consists of a centre pillar (34) provided in center of the upper part of the lower cover, a turning wheel (4) sleeved on the centre pillar, a brake component (5) provided in the upper part of the lower cover and a vulture spring (6) fixed inside of the turning wheel. An annular groove (7) is formed on the bottom part of the turning wheel and the bottom of the annular groove is flat. A positioning device (8) is provided in the annular groove for separating the annular groove. The annular groove is divided into guiding groove (9) by the positioning device. The brake component can be embedded into the guiding groove and moves relatively along the guiding groove (9) when the turning wheel (4) rotates.

### FIELD OF THE INVENTION

The present invention relates to a cable winder, more specifically, a device that allows user to extend the cable manually and retract it automatically.

### DESCRIPTION OF PRIOR ART

Most electronic devices are equipped with cables for transmitting electricity or data. Those devices improve our life, however, unorganized cables become a problem. They are easily to get tangled, causing difficulty when separating a device from others or raising safety issues as they may cause accident. Therefore, the cable winder is utilized to store and adjust the cable of the electronic device.

Conventional cable winder uses a coil spring to generate a force for retracting the cable. Some cable winders includes a ratchet mechanism or a backstop member for providing a positioning feature, such as the cited reference 1, CN 200520018519.9, entitled “Two-way Cable Winder”.

Another mechanism is also selected for positioning the cable. Said mechanism includes a turning wheel, a hook or stop member and a predetermined track. When the cable is extending or retracting, the wheel rotates, driving said hook member to move along the predetermined track. Multiples positioning holes are preset on the track to allow the hook member engage the hole temporally, providing positioning feature. Such mechanism is disclosed in the cited reference 2, CN 200420102869.9, entitled “An Automatic Wire Winder” and cited reference 3, CN 20072018531.0, entitled “A Wire Winder”.

Unfortunately, winding mechanisms disclosed in the documents possesse defect. For example, in the cited reference 3, a roller ball as a stop member, moves within a track with raceways of different heights to achieve the positioning feature. The raceways are set in different heights for changing the moving directions of the roller ball. The stop member impacting the raceways generates noise and can also damage both the raceways and stop member eventually. Therefore, to design a device for retracting cable automatically with quietness and durability has become the main objective of the present invention.

### SUMMARY OF THE INVENTION

For achieving foregoing objective, an automatic positioning winder comprising a lower cover (1), an upper cover (2) fixed to said lower cover (1), a winding device provided between said lower (1) and upper covers (2), an entering and outgoing line hole (10, 11) formed on both lateral walls of the lower (1) and upper (2) covers respectively. Said winding device consists of a centre pillar (34) provided in a center of an upper portion of the lower cover (1), a turning wheel (4) sleeved on the centre pillar (34), a brake component (5) provided in the upper portion of the lower cover (1) and a vulture spring (6) fixed inside of the turning wheel; an annular groove (7) having a flat bottom is formed on the bottom portion of the turning wheel (4). Said annular groove (7) includes a positioning device (8) for forming a guiding groove (9) inside the annular groove (7). The brake component (5) is embedded into the guiding groove (9) and moves relatively along the guiding groove (9) as said turning wheel (4) rotates.

The spiral spring (6) is arranged in the turning wheel (4). A channel (12) is provided on the lateral wall of the centre pillar (34) and another channel (13) provided on lateral wall of the turning wheel (4). An end of said spiral spring (6) is fixed to the groove (12) of the centre pillar (34) and another end fixed to the channel (13) of the turning wheel (4).

Said positioning device (8) includes a U-shaped convex portion (14), a wedge shaped convex portion (15) and a convex cylindrical portion (16) provided in the centre of the turning wheel (4). Said U-shaped (14) and wedge shape convex (15) portions form an outer raceway (17) and an inner raceway (18) in the annular groove (7); an inlet channel (19) is set between the U-shaped convex (14) and an end of the wedge shape convex (15) and an exit channel (20) is set between the U-shaped convex (14) and another end of the wedge shape convex (15). The wedge shape convex (15) further includes a U-shaped opening (21) connecting the exit channel (20). When the turning wheel (4) rotates, the brake component (5) moves along the outer raceway (17) and the lower cover (1), rotating 270 degree from a first position (22) toward to a second position (23) and is guided into the inner raceway (18) by the inlet channel (19). The brake component (5) rotates 90 degrees and moves from the second position (23), passing the inlet channel (19) to a third position (24). The brake component (5) rotates another 90 degrees by the inertia, moving from the third position (24) toward a forth position (25) along the inner raceway (18), then toward a fifth position (26); both the forth (25) and fifth (26) positions are provided on a same circumference; an end of the U-shaped opening (21) extending and joining said circumference, allowing the brake component (5) rotates 90 degrees, entering a sixth position (27) whereat a concave portion of the opening (21). The brake component (5) rotates another 90 degrees by inertia and forwarding from the sixth position (27) passing a seventh position (28) at a tip end of the U-shaped convex (14) toward an eighth position (29) at an upper end of the U-shaped convex (14). Both the sixth (27) and seventh (28) positions are provided on a same circumference. An end of the U-shaped convex (14) extending and joining said circumference, allowing the brake component (5) of eighth position rotates 90 degrees, returning to the first position (22).

The shape of said brake component (5) can be selected from a spherical shape, a L-shape, a cylindrical shape and an elongated shape.

Another embodiment for the invention, wherein an automatic positioning winder comprising a lower cover (1), an upper cover (2) fixed to said lower cover (1), a winding device provided between said lower (1) and upper covers (2), entering and outgoing line holes (10, 11) formed in the lateral walls of the lower and upper covers respectively. Said winding device consists of a centre pillar (34) provided in center of an upper portion of the lower cover (1), a turning wheel (4) sleeved on the centre pillar (34), a brake component (50) provided in the upper portion of the lower cover (1) and a spiral spring (6) fixed inside of the turning wheel. An annular groove (7) with a flat bottom is formed on the bottom portion of the turning wheel (4). Said annular groove (7) includes pluralities of positioning devices (8) for forming guiding groove (9) inside the annular groove (7). The brake component (50) has a hook portion (500) moving along said guiding groove (9) against rotation of the turning wheel (4); said guiding groove (9) includes a flat bottom and the hook (500) of said brake component moves along the lateral wall of the guiding groove (9) to change moving direction; a circular convex portion (14) and a wedge shape convex portion (15) are provided in the guiding groove (9), forming an outer raceway (17) and an inner raceway (18); said circular (14) and wedge shape (15) convex are spaced by an inlet channel (19) and an outlet channel (20), and an end of the wedge shape convex (15) includes a concave opening (21) connecting the outlet channel (20) A turning radius (R1) of said inlet channel is greater than a turning radius (R2) of an inner side of a tip end of the opening (21) and a turning radius (R3) of the concave opening (21) is greater than a turning radius (R4) of an inner side of a tip end, where is close said outlet channel, of said circular convex (14).

The turning wheel (4) has a compartment (41) on a bottom thereof for accommodating said brake component (50) within and said hook (500) is extended from a groove (42), disposed on the bottom of the wheel (4), and engaged with the guiding groove (9).

Said brake component (5) comprising an elongated arm portion (501), a circular portion (502) and said hook portion (500), which is perpendicular with the circular portion (502).

Four lateral walls and both upper and lower face of said compartment (41) are set to restrain movement of the circular portion (502) of the brake compartment (50).

In contrast of aforementioned cited documents, the brake component disclosed in the present invention is attached onto the turning wheel and having the guiding groove set on the lower cover; moreover, the shapes and structure selected for the brake component can improve the performance thereof.

In conclusion, the brake component of the present invention is moving relatively along the lateral wall of the guiding groove by inertia, thus no step-like structure is needed to apply to the groove for changing the moving direction of the brake component. It avoids the brake component impacting the groove as falling, eliminating the noise and prolonging the service life of the cable winder.

### BRIEF DESCRIPTION OF DRAWINGS

FIG. 1 is a perspective view of the first embodiment of the present invention.

FIG. 2 is a cross sectional view of the turning wheel of the first embodiment of the present invention.

FIG. 3 is an exploded view of the first embodiment of the present invention.

FIG. 4 is an explanatory view of the first embodiment of the present invention, showing movement of the brake member and relating guiding channel.

FIG. 5 is a perspective view of the turning wheel.

FIG. 6 is a perspective view of the second embodiment of the present invention.

FIG. 7 is a cross sectional view of the turning wheel of the second embodiment of the present invention.

FIG. 8 is a perspective view of the lower cover and brake component of the second embodiment of the present invention.

FIG. 9 is an illustrative view of guiding channel of the second embodiment of the present invention.

FIG. 10 is a perspective view of the brake component having a L-shape.

FIG. 11 is another perspective view of the brake component having a L-shape

FIG. 12 is a perspective view of the brake component having a cylindrical shape.

FIG. 13 is a perspective view of the brake component having an elongated shape.

### DETAILED DESCRIPTION OF PREFERRED EMBODIMENTS

The preferred embodiments of the present invention are described according appended drawings hereinafter.

### First Embodiment

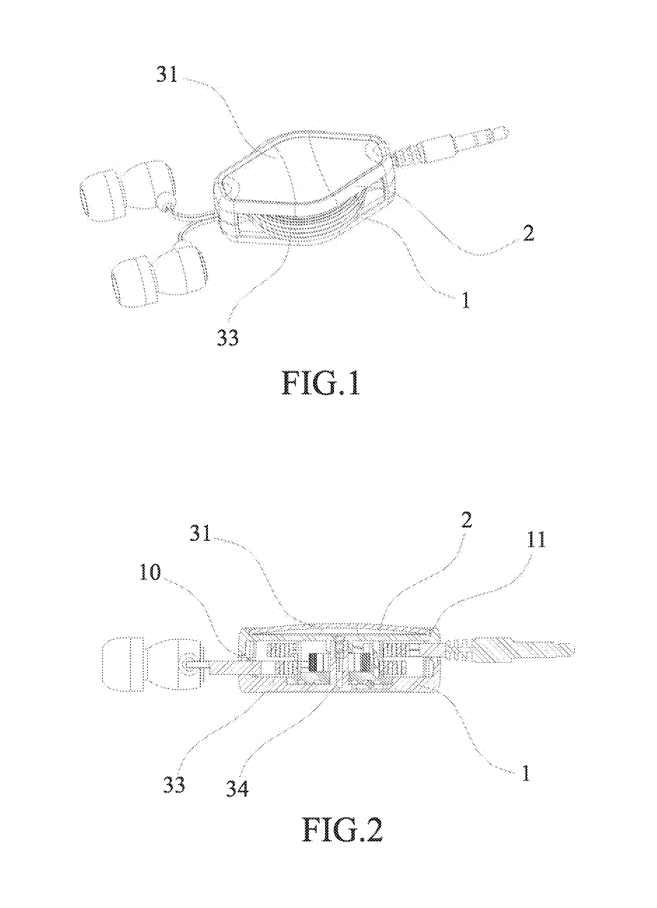

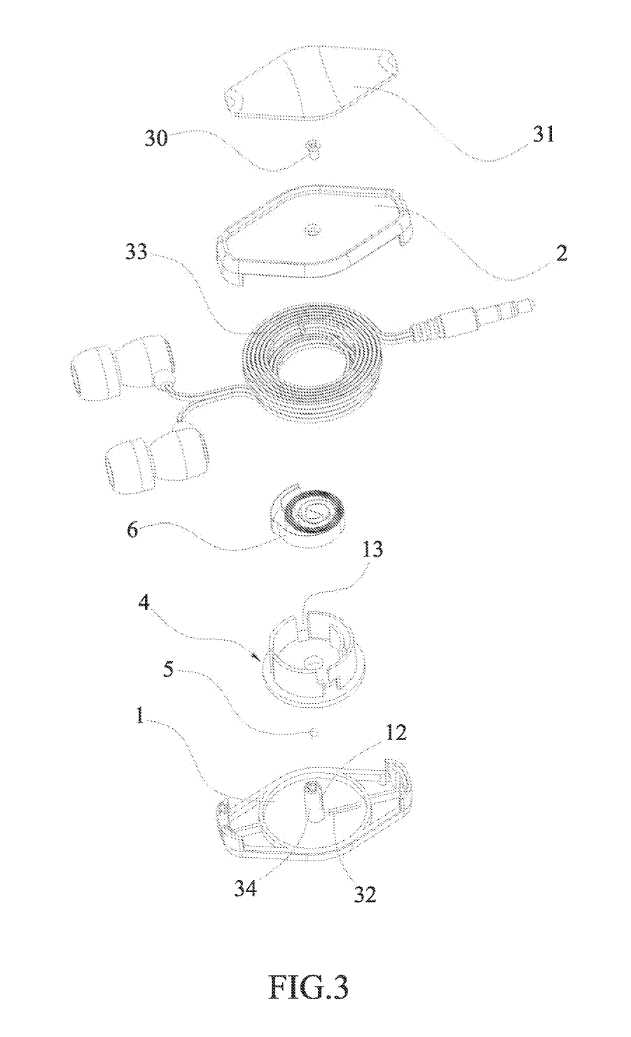

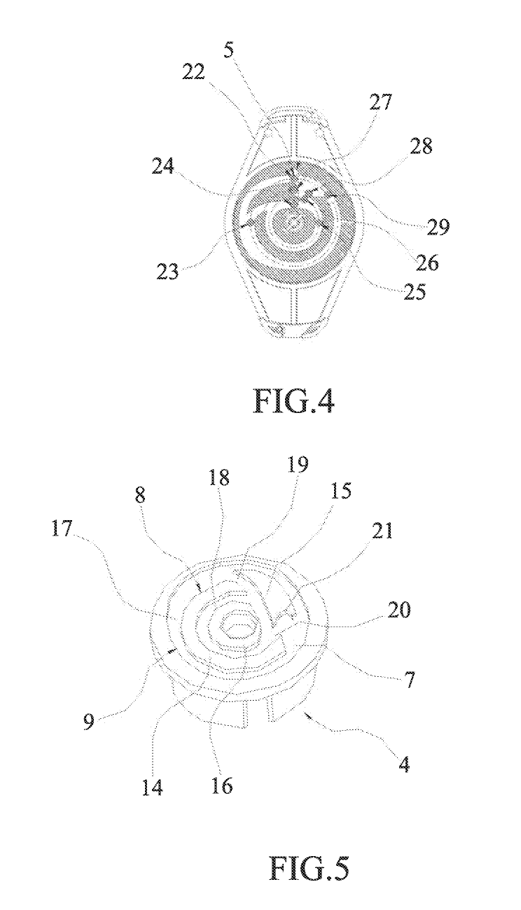

Referring to FIGS. 1-5, an automatic positioning winder comprising a lower cover (1), an upper cover (2) fixed to said lower cover (1), a winding device provided between said lower (1) and upper covers (2), an entering and outgoing line hole (10, 11) formed on both lateral walls of the lower (1) and upper (2) covers respectively for allowing cable to pass through.

Said winding device consists of a centre pillar (34) attached to a center of an upper portion of the lower cover (1), a turning wheel (4) sleeved on the centre pillar (34), a brake component (5) provided in the upper portion of the lower cover (1) and a vulture spring (6) fixed inside of the turning wheel. An annular groove (7) having a flat bottom is formed on the bottom portion of the turning wheel (4) and said annular groove (7) includes a positioning device (8) for forming pluralities guiding groove (9) inside the annular groove (7). The brake component (5) is embedded into the guiding groove (9) and moves relatively along the guiding groove (9) as said turning wheel (4) rotates.

The brake component (5) has a spherical shape, such as a metallic roller ball. Said lower cover (1) includes a raceway (32) for receiving the lower half of the brake component (5) and allowing it to roll within. The upper half of the brake component (5) can be received by the guiding groove (9).

Said positioning device (8) includes a U-shaped convex portion (14), a wedge shaped convex portion (15) and a convex cylindrical portion (16) provided in the centre of the turning wheel (4). Said U-shaped (14) and wedge shape convex (15) portions form an outer raceway (17) and an inner raceway (18) in the annular groove (7); an inlet channel (19) is set between the U-shaped convex (14) and an end of the wedge shape convex (15) and an exit channel (20) is set between the U-shaped convex (14) and another end of the wedge shape convex (15). The wedge shape convex (15) further includes a U-shaped opening (21) adjacent the exit channel (20). When the turning wheel (4) rotates, the brake component (5) moves along the outer raceway (17) and the lower cover (1), rotating 270 degree from a first position (22) toward to a second position (23) and is guided entering the inner raceway (18) by the inlet channel (19). The brake component (5) rotates 90 degrees and moves from the second position (23), passing the inlet channel (19) to a third position (24). The brake component (5) rotates another 90 degrees by the inertia, moving from the third position (24) toward a forth position (25) along the inner raceway (18), then toward a fifth position (26); both the forth (25) and fifth (26) positions are provided on a same circumference; an end of the U-shaped opening (21) extending and joining said circumference, allowing the brake component (5) rotates 90 degrees, entering a sixth position (27) of the opening (21). The brake component (5) rotates another 90 degrees by inertia and forwarding from the sixth position (27) passing a seventh position (28) at a tip end of the U-shaped convex (14) toward an eighth position (29) at an upper end of the U-shaped convex (14). Both the sixth (27) and seventh (28) positions are provided on a same circumference. An end of the U-shaped convex (14) is extending and joining said circumference, allowing the brake component (5) of eighth position rotates 90 degrees, returning to the first position (22).

The spiral spring (6) is arranged in the turning wheel (4). A channel (12) is provided on the lateral wall of the centre pillar (34) and another channel (13) provided on lateral wall of the turning wheel (4). An end of said spiral spring (6) is fixed to the groove (12) of the centre pillar (34) and another end fixed to the channel (13) of the turning wheel (4).

Pluralities of tap holes are set on top of the centre pillar (34) and pluralities of passage holes corresponding said tap holes are also set on top of the upper cover (2). A screw (30) is inserted from said upper cover (2), passing the passage hole and the tap hole of the centre pillar, coupling said upper (2) and lower (1) cover. A decorating plate (31) is attached to the top of the upper cover (2).

A cable (33) is winded onto said turning wheel (4), having an end extended from the entering hole (10) and another extended from the outgoing hole (11). The cable (33) can be stretched by pulling both extreme ends simultaneously. As the cable (33) is stretching, the brake component (5) is led into the inner raceway (18), moving counter-clockwise direction, since a tip end of the opening (21) is reaching in a middle of the passage way of channel (18), the brake component (5) is led into the sixth position (27), the concave portion of the opening (21), and securing the position of the cable (33).

The cable (33) can be stretched to readjust the length until it is extended to the maximum. For retracting, the cable (33) is pulled slightly, causing brake component (5) be released from the sixth position (27), passing seventh position (28) and reaching eighth position (29), thus the brake component (5) moves along the outer raceway (17), not the inner raceway (18), and the cable (33) returns to its initial position.

### Second Embodiment

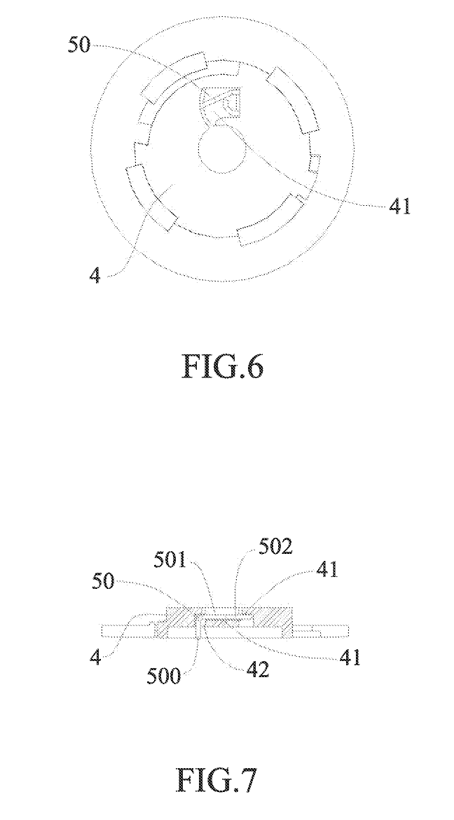

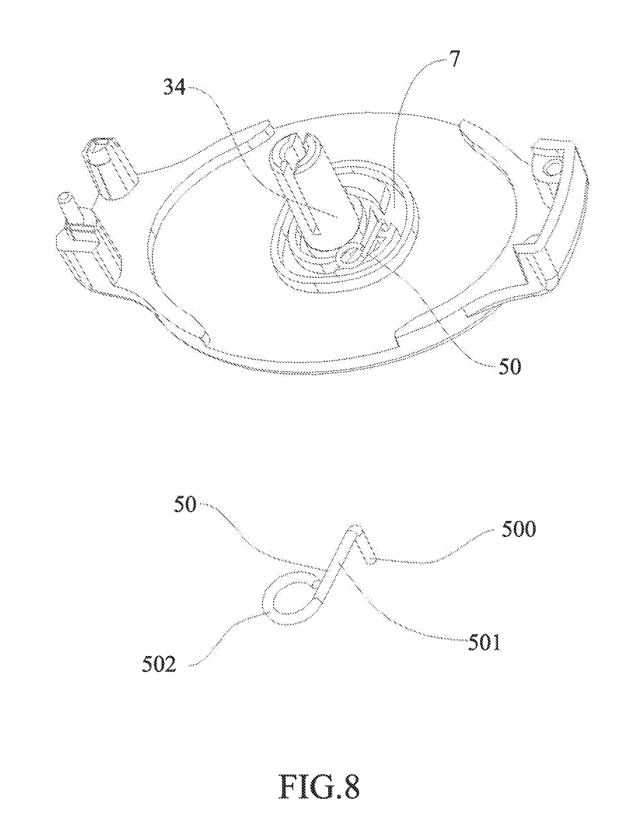

Another embodiment of the invention is disclosed referring to FIGS. 6-8. Unlike the first embodiment, the brake component (50) of this embodiment has an elongated post-like shaped, not a spherical shape as disclosed previously, and the guiding groove (9) is provided at a different place. The brake component (50) is attached to the bottom of the turning wheel (40) and said annular groove (7), positioning device (8) and guiding groove (9) are set in an inner face of the lower cover (1).

The turning wheel (4) has a compartment (41) on a bottom thereof for accommodating said brake component (50) within and said hook (500) is extended from a groove (42), disposed on the bottom of the wheel (4), and engaged with the guiding groove (9).

Said brake component (50) comprising an elongated arm portion (501), a circular portion (502) for allowing the component (50) can rotate freely and said hook portion (500), which is perpendicular with the circular portion (502). The hook portion (500) functions as same as said spherical shaped brake component (5), thus no detail function is described herein.

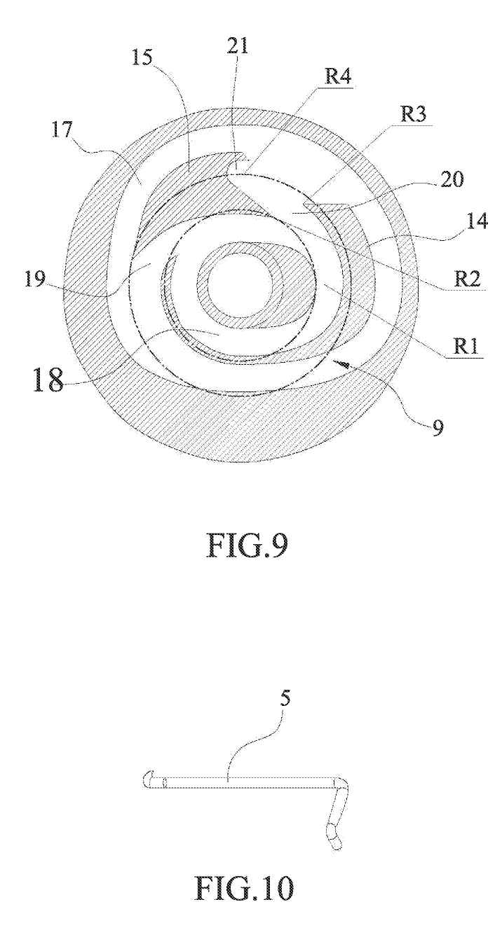

As show in FIG. 9, the bottom of the guiding groove (9) is flat; the hook (500) changes its moving direction by sliding along the side wall of the guiding groove (9). A circular convex portion (14) and a wedge shape convex portion (15) are provided in the guiding groove (9), forming an outer raceway (17) and an inner raceway (18). The circular (14) and wedge shape (15) convex are spaced by an inlet channel (19) and an outlet channel (20), and an end of the wedge shape convex (15) includes a concave opening (21) connecting the outlet channel (20). Said guiding groove (9) has a rotating centre (0), and a turning radius (R1) of said inlet channel is greater than a turning radius (R2) of an inner side of a tip end of the opening (21) and a turning radius (R3) of the concave opening (21) is greater than a turning radius (R4) of an inner side of a tip end of said circular convex (14), where is close said outlet channel.

The brake component (50) is preferably made of steel. Furthermore, to avoid said hook-like brake component (50) disengages from the guiding groove (9) by external force applied to the device, four lateral walls and both upper and lower face of said compartment (41) are set to restrain movement of the circular portion (502) of the brake component (50).

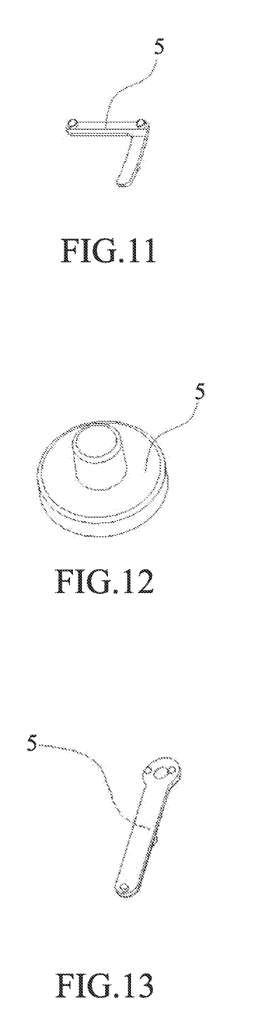

Besides the spherical and a hook-like shape, the shape of said brake component (5) can also be selected from a L-shape, a cylindrical shape and an elongated shape as shown in FIGS. 10-13.

The guiding groove (9), disposed at bottom of the turning wheel (4), is designed using the inertia force to allow the brake component (5, 50) of both embodiments travel within the outer and inner raceways (17, 18), which are provided concentrically encircling the centre of the lower cover (1). The present invention has been described via the detailed illustration of the preferred embodiments. Those skilled in the art can derive variations from the preferred embodiment without departing from the scope of the present invention, for example the shapes of the outer and inner raceways (17, 18), the brake component (5) and the raceway (32). Therefore, the preferred embodiment shall not limit the scope of the present invention defined in the claims.

1. An automatic positioning winder comprising a lower cover (1), an upper cover (2) fixed to said lower cover (1), a winding device provided between said lower (1) and upper covers (2), entering and outgoing line holes (10, 11) formed in the lateral walls of the lower and upper covers respectively; characterized in that: said winding device consists of a centre pillar (34) provided in center of an upper portion of the lower cover (1), a turning wheel (4) sleeved on the centre pillar (34), a brake component (5) provided in the upper portion of the lower cover (1) and a spiral spring (6) fixed inside of the turning wheel; an annular groove (7) with a flat bottom is formed on the bottom portion of the turning wheel (4); said annular groove (7) includes a positioning device (8) for forming a guiding groove (9) inside the annular groove (7); the brake component (5) is embedded into the guiding groove (9) and moves relatively along the guiding groove (9) as said turning wheel (4) rotates.

2. The automatic positioning winder of claim 1, wherein said spiral spring (6) is winded and arranged within the turning wheel (4); a channel (12) is provided on the lateral wall of the centre pillar (34) and another channel (13) provided on lateral wall of the turning wheel (4); an end of said spiral spring (6) is fixed to the groove (12) of the centre pillar (34) and another end fixed to the channel (13) of the turning wheel (4).

3. The automatic positioning winder of claim 1, wherein said positioning device (8) includes a U-shaped convex portion (14), a wedge shaped convex portion (15) and a convex cylindrical portion (16) provided in the centre of the turning wheel (4); said U-shaped convex (14) and wedge shape convex (15) form an outer raceway (17) and an inner raceway (18) in the annular groove (7); an inlet channel (19) is set between the U-shaped convex (14) and an end of the wedge shape convex (15) and an exit channel (20) is set between the U-shaped convex (14) and another end of the wedge shape convex (15); the wedge shape convex further includes a U-shaped opening (21) connecting the exit channel (20); when the turning wheel (4) rotates, the brake component (5) moves oppositely along the outer raceway (17) and encircling a centre the lower cover (1), wheeling 270 degrees from a first position (22) toward to a second position (23) and is guided into the inner raceway (18) by the inlet channel (19); the brake component (5) spins 90 degree and moves from the second position (23), passing the inlet channel (19) to a third position (24); the brake component (5) rotates another 90 degrees by the inertia, moving from the third position (24) toward a forth position (25) along the inner raceway (18), then toward a fifth position (26); both the forth (25) and fifth (26) positions are provided on a same circumference; an end of the U-shaped opening (21) extending and joining said circumference, allowing the brake component (5) rotates 90 degrees, entering a sixth position (27) of a concave portion of the opening (21); the brake component (5) rotates another 90 degrees by inertia and forwarding from the sixth position (27) passing a seventh position (28) at a tip end of the U-shaped convex (14) toward an eighth position (29) at an upper end of the U-shaped convex (14); both the sixth (27) and seventh (28) positions are provided on a same circumference; an end of the U-shaped convex (14) extending and joining said circumference, allowing the brake component (5) of eighth position rotates 90 degrees, returning to the first position (22).

4. The automatic positioning winder of claim 1, wherein a shape of said brake component (5) is selected from a spherical shape, a L-shape, a cylindrical shape and an elongated shape.

5. The automatic positioning winder of claim 1, wherein pluralities of tap holes are set on top of the centre pillar (34) and pluralities of passage holes corresponding said tap holes are set on top of the upper cover (2); a screw (30) is inserted from said upper cover (2), passing the passage hole and the tap hole of the centre pillar, coupling said upper (2) and lower (1) cover.

6. The automatic positioning winder of claim 1, wherein a decorative plate (31) is coupled to the top of said upper cover (2).

7. An automatic positioning winder comprising a lower cover (1), an upper cover (2) fixed to said lower cover (1), a winding device provided between said lower (1) and upper covers (2), entering and outgoing line holes (10, 11) formed in the lateral walls of the lower and upper covers respectively; characterized in that: said winding device consists of a centre pillar (34) provided in center of an upper portion of the lower cover (1), a turning wheel (4) sleeved on the centre pillar (34), a brake component (50) provided in the upper portion of the lower cover (1) and a vulture spring (6) fixed inside of the turning wheel (4); an annular groove (7) having a flat bottom is formed on the bottom portion of the turning wheel (4); said annular groove (7) includes a positioning device (8) for forming a guiding groove (9) inside the annular groove (7); the brake component (50) has a hook portion (500) moving relatively along said guiding groove (9) as the turning wheel (4) rotating; said guiding groove (9) includes a flat bottom and the hook (500) of said brake component moves along the lateral wall of the guiding groove (9) to change its moving direction; a circular convex portion (14) and a wedge shape convex portion (15) are provided in the guiding groove (9), forming an outer raceway (17) and an inner raceway (18); said circular (14) and wedge shape (15) convex are spaced by an inlet channel (19) and an outlet channel (20), and an end of the wedge shape convex (15) includes a concave opening (21) connecting the outlet channel (20); a turning radius (R1) of said inlet channel (19) is greater than a turning radius (R2) of an inner side of a tip end of the opening (21) and a turning radius (R3) of the concave opening (21) is greater than a turning radius (R4) of an inner side of a tip end of said circular convex (14), where is close said outlet channel (20).

8. The automatic winder of claim 7, wherein the turning wheel (4) has a compartment (41) on a bottom thereof for accommodating said brake component (50) within; said hook (500) is extended from a groove (42), disposed on the bottom of the wheel (4), and engaged with the guiding groove (9).

9. The automatic winder of claim 8, wherein said brake component (50) comprising an elongated arm portion (501), a circular portion (502) for providing freely rotation and said hook portion (500), which is perpendicular with the circular portion (502).

10. The automatic winder of claim 9, wherein four lateral walls and both upper and lower face of said compartment (41) are set to restrain movement of the circular portion (502) of the brake component (50).
